(19) United States
(12) Patent Application Publication
(10) Pub. No.: US 2014/0103699 A1
(43) Pub. Date: Apr. 17, 2014

(54) BALANCING WEIGHT HAVING AN ADHESIVE THAT CAN BE ACTIVATED

(71) Applicant: Wegmann automotive GmbH & Co. KG, Veitshochheim (DE)

(72) Inventors: Dietmar WAGENSCHEIN, Veitshochheim (DE); Felix BODE, Veitshochheim (DE); Thomas HORNUNG, Wurzburg (DE)

(73) Assignee: Wegmann automotive GmbH & Co. KG, Veitshochheim (DE)

(21) Appl. No.: 14/141,213

(22) Filed: Dec. 26, 2013

Related U.S. Application Data
(63) Continuation of application No. PCT/EP2012/062472, filed on Jun. 27, 2012.

(30) Foreign Application Priority Data
Jun. 27, 2011 (EP) 11171539.7

(51) Int. Cl. F16F 15/34; F16F 15/32

(52) U.S. Cl. CPC F16F 15/345; F16F 15/324
USPC 301/5.21

(57) ABSTRACT

A balancing weight for vehicle wheels, which has a weight body and an adhesive means for bonding the weight body to a rim of the vehicle, wherein the adhesive means is heatable by means of electromagnetic radiation.

### PRIORITY CLAIM

This application is a continuation of pending International Application No. PCT/EP2012/062472 filed on 27 Jun. 2012, which designates the United States and claims priority from European Application No. 11171539.7 filed on Jun. 27, 2011, both of which are incorporated by reference in their entireties.

### BACKGROUND OF THE INVENTION

1. Field of the Invention

The invention relates to a balancing weight for vehicle wheels, which has a weight body and an adhesive means for bonding the weight body to a rim of a vehicle.

2. Description of Relevant Art

An balancing weight for vehicle wheels is disclosed in DE 101 02 321 A1. The use of a double-sided adhesive tape is disclosed therein for attaching the balancing weight to a rim. Such an adhesive tape may have at least three parts. In general, a foam is also arranged between two adhesive strips, to be able to absorb irregularities in thickness of the rim of the vehicle wheel, in which the balancing weight is used. When detaching the balancing weights, the problem arises that the foam layer tears and the adhesive strip located on the rim side and some foam residues remain on the rim. These must then be removed thereafter in a complex procedure.

### SUMMARY OF THE INVENTION

The embodiments are based on the object of providing a balancing weight, which can be easily applied to a rim, has a high retention force at the rim and can be removed easily after use.

In an embodiment, a balancing weight is provided, having an adhesive means, which can be heated and/or activated by means of electromagnetic radiation. The adhesive means can have a foam, i.e., the actual adhesive means can be formed in two parts, alternatively, however, it is also possible that the adhesive means is formed in one part and without foam. Because of the ability to heat it by means of electromagnetic radiation, the adhesive means can be heated to detach the adhesive weight, whereby the balancing weight is removable more or less without residue from the rim of the vehicle wheel.

Preferably, heating by means of electromagnetic radiation of the adhesive means may be done without physical contact between the heat source and the adhesive tape and/or balancing weight. All wavelengths are included which are usable for heating, in particular radio-frequency waves, ultraviolet waves, and microwaves. The vehicles to which the balancing weights according to the invention can be attached comprise, of course, passenger automobiles, utility vehicles, and also motorcycles and other vehicles on which balancing weights are attached.

The adhesive means is advantageously cross-linkable or polymerizable or activatable as a result of the heating. Cross-linkable means that it only receives its adhesive capability as a result of the heating. Activation is understood, in contrast, to mean that the contact capability or adhesive capability of an already solid or also glued adhesive means is recovered.

The adhesive means preferably contains metallic particles. The particles are most preferably implemented as nanoferrites. Nanoferrites are iron oxide particles which have a large specific surface area. They are super-paramagnetic. Nanoferrites designate ferrites which have a particle size of less than 30 nm. These allow the heating of the adhesive means, by absorbing energy from electromagnetic alternating fields and discharging the energy to the environment again as heat. Adhesive means, which are themselves only very poor microwave absorbers, can thus be inductively heated.

It may also be possible to heat the weight bodies of the balancing weight and thus to transfer the heat to the adhesive means. Because of the energy stored in the weight body, the hardening procedure of the adhesive means would then occupy a longer period of time than in the case of the use of nanoferrites.

The nanoferrites may be doped using magnesium or nickel or copper or zinc.

Instead of nanoferrites or in addition thereto, the adhesive means may have at least one metal inlay. This may be either a type of rectangular baseplate or also a grating or rods incorporated into the adhesive means. Preferably, the metal inlays are adapted to the shape of the weight body. For example, there are flat and curved weight bodies. The metal inlays may be flat or curved depending on the shape of the weight body. The metal inlays preferably comprise iron, steel, zinc, lead, a zinc alloy, or a lead alloy. Of course, any other material is also usable, which is suitable for energy absorption via microwaves and for discharging this energy by means of heat or also for forming eddy currents and corresponding heat introduction.

The adhesive means may advantageously comprise a single-component adhesive, which is activated after the electromagnetic heating and is bondable to the rim of the vehicle. It is thus an adhesive, which only develops its adhesive effect after heating above a threshold temperature. This threshold temperature is at least greater than possible outside temperatures, ideally it is approximately in the range of 100° C. The adhesive of the adhesive means is thus prevented from liquefying again in running operation of the motor vehicle and the balancing weight is prevented from being lost during operation of the motor vehicle. The activation process described herein may also be applicable for removal of the adhesive weight.

In a further embodiment, the adhesive means may comprise a two-component adhesive, whose components are to be mixed for the cross-linking. The adhesive can then be heated again by means of electromagnetic radiation in the event of a change of the balancing weight and thus become activated, because of which the balancing weight is removable without residue. In one embodiment, the two-component adhesive is also to be heated for the cross-linking, i.e., the cross-linking reaction is first activatable at a predefined temperature.

The adhesive means is preferably implemented as an adhesive strip. Accordingly, it has a substantially constant thickness, independently of whether the weight body is flat or curved. The required energy introduction per area section is thus constant, whereby uniform heating of the adhesive means is achievable.

In another embodiment, the weight body may comprise a material which is not heatable by means of electromagnetic radiation. For example, plastic is known as such a material. The heat is thus only introduced into the adhesive means, whereby a heat discharge by the weight body into the adhesive means, which is not always precisely predictable, is avoided.

According to a further embodiment, the weight body may comprise a material which is heatable by means of electromagnetic radiation. For example, iron, steel, zinc, lead, zinc alloys, or lead alloys are known as such materials. Steel is also understood in this application as any type of stainless steel. Such a weight body permits more rapid energy introduction, in that a higher level of energy can be introduced into the balancing weight in the same time, which is then stored in the weight body. A longer-term heat discharge is thus possible.

### BRIEF DESCRIPTION OF THE DRAWINGS

In the following, the invention will be described by way of example, without limitation of the general inventive concept, on examples of embodiment and with reference to the drawings.

FIG. 1 shows a balancing weight in a first embodiment,

FIG. 2 shows an balancing weight in a second embodiment,

FIG. 3 shows an balancing weight in a third embodiment, and

FIG. 4 shows an balancing weight in a fourth embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

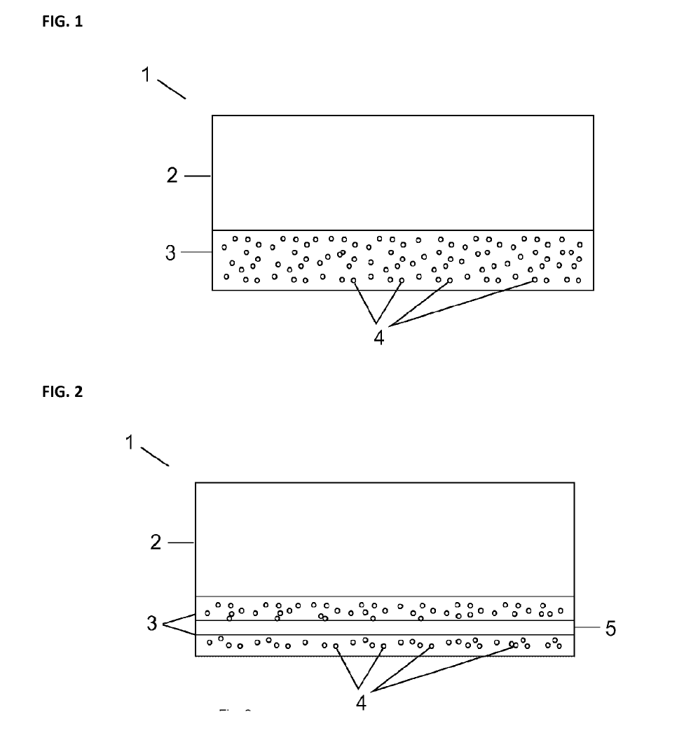

FIG. 1 shows a section of a balancing weight 1 having a weight body 2 and an adhesive means 3. Nanoferrites 4 are incorporated in the adhesive means 3. The most uniform possible distribution of the nanoferrites 4 in the adhesive means 3 is desired. A removable film can still be provided on the side of the adhesive means 3 facing away from the weight body, which is removed before heating of the adhesive means 3.

Due to the heating of the adhesive means 3, the provision of a foam 5 in the middle of the adhesive means 3 is no longer required, but may still be provided. A corresponding embodiment is shown, for example, in FIG. 2.

In the balancing weight shown in FIG. 1, adaptability to the irregularities in thickness of the rim of a vehicle is basically provided in that after the heating of the adhesive means 3, it has a moldable surface and accordingly absorbs irregularities in thickness.

Of course, a device which emits electromagnetic waves, in particular microwaves, for example, a coil, is necessary for heating the adhesive means 3. The energy transferred by means of the waves or via the coil is stored in the nanoferrites 4, converted into heat, and discharged to the surrounding adhesive of the adhesive means 3. After the heating, the adhesive means or its adhesive is activated and is bondable to the rim, so that after cooling, a solid bond results between the balancing weight 1 and the rim by means of the adhesive means 3. Polyurethane and epoxy adhesives and also acrylic adhesives suggest themselves as the adhesive of the adhesive means 3. This activation can also be performed to remove the balancing weight 1, whereby the balancing weight 1 is removable without residue.

As already explained, the provision of foam 5 is still possible, wherein such a layer has become superfluous per se in consideration of the heating of the adhesive means 3.

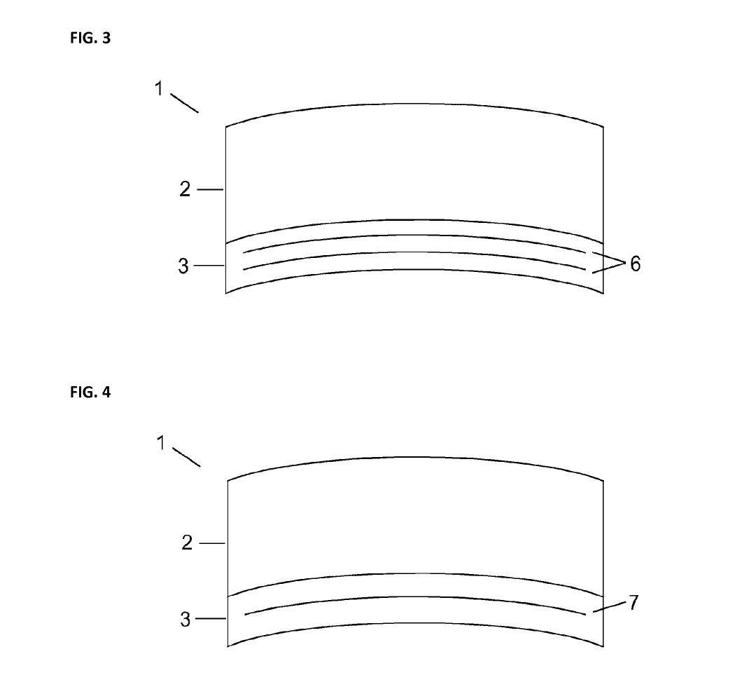

FIG. 3 shows an balancing weight 1 having a basic shape which is curved in cross-section. The adhesive means 3 or the metal rods 6 contained therein are adapted to the shape and are also curved. At least one metal rod 6 is located in the adhesive means 3, however, multiple metal rods 6 can also be arranged in the adhesive means 3.

Instead of metal rods 6, a metal plate 7 may be arranged in the adhesive means 3, as shown in FIG. 4. The metal plate 7 can be slotted, but it may also have a solid body. FIG. 4 shows a shape of the weight body 2 which is curved in cross-section, because of which the metal plate 7 is also curved in cross-section. In the case of flat formation of the weight body 2, the metal plate 7 may also be embodied as flat in cross-section.

The nanoferrites 4 may also be used in the case of curved shapes of the weight body 2.

By the heatability of the adhesive means 3 of the balancing weight 1, it is possible, on the one hand, to fasten the balancing weight 1 to any kind of rims of motor vehicles. On the other hand, the balancing weight 1 may also be removed again without residue.

It is to be noted that FIGS. 1 to 4 only show sections of an balancing weight 1 in cross-section. The weight bodies of balancing weights are typically subdivided with respect to weight and provided with notches for this purpose. A section between two such notches is shown in each of the figures.

FIG. 1 shows a cross-section . . .

It will be appreciated to those skilled in the art having the benefit of this disclosure that this invention is believed to provide adhesive balancing weights. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 balancing weight
2 weight body
3 adhesive means
4 nanoferrites
5 foam
6 metal rod
7 metal plate

1. A balancing weight for vehicle wheels, comprising:
a weight body; and
an adhesive configured to bond the weight body to a rim of a vehicle wheel,
wherein the adhesive is configured to be heated by electromagnetic radiation.

2. The balancing weight according to claim 1, wherein the adhesive is configured to be cross-linked or activated by the heating.

3. The balancing weight according to claim 1, wherein the adhesive comprises metallic particles.

4. The balancing weight according to claim 1, wherein the adhesive comprises nanoferrites.

5. The balancing weight according to claim 4, wherein the nanoferrites are doped with at least one of magnesium or nickel or copper or zinc.

6. The balancing weight according to claim 1, wherein the adhesive has at least one metal inlay.

7. The balancing weight according to claim 6, wherein the metal inlay has a substantially rectangular shape.

8. The balancing weight according to claim 1, wherein the adhesive comprises a single-component adhesive, which is activated after the heating and is bondable to the rim of a vehicle.

9. The balancing weight according to claim 1, wherein the adhesive comprises a two-component adhesive, whose components are to be mixed for the cross-linking.

10. The balancing weight according to claim 1, wherein the adhesive is implemented as an adhesive strip.

11. The balancing weight according to claim 1, wherein the weight body consists of a material, in particular plastic, which is not heatable by electromagnetic radiation.

12. The balancing weight according to claim 1, wherein the weight body comprises a material which is configured to be heated by electromagnetic radiation.

13. The balancing weight according to claim 12, wherein the material comprises at least one of: steel, zinc, zinc alloy, lead, or lead alloy.
